(19) United States
(12) Patent Application Publication
(10) Pub. No.: US 2008/0252080 A1
(43) Pub. Date: Oct. 16, 2008

(54) Gasoline Generator

(75) Inventor: Henglin Xiao, Wuxi (CN)

Correspondence Address: HAMRE, SCHUMANN, MUELLER & LARSON, P.C., P.O. BOX 2902, MINNEAPOLIS, MN, 55402-0902, US

(73) Assignee: WUXI KIPOR POWER CO., LTD., Wuxi (CN)

(21) Appl. No.: 10/586,172

(22) PCT Filed: Jan. 4, 2005
(86) PCT No.: PCT/CN2005/000012

§ 371 Date: Jul. 1, 2008

(30) Foreign Application Priority Data
Apr. 13, 2004 (CN) 200420026342.2

(51) Int. Cl. F02B 63/04; F01P 5/02

(52) U.S. Cl. 290/1 A; 123/2; 123/41.66

(57) ABSTRACT

The present invention relates to a gasoline generator, belongs to the technical field of motive power equipment. Wherein the gasoline engine set in an enclosed case, a permanent magnet generator is mounted on the engine housing, handle tray mounted on the fore end surface of cool air suction cover, suction cover is joined to the engine housing handle tray, joined to the suction cover, together forms the main cooling air channel for the motive power. The present invention provides a simple, compact and rational structure. Air guide plate and the cool air suction cover envelop all the high temperature parts of the engine and the generator, exhaust pipe and muffler as a whole. Cool air sucked in by the suction fan provides specific and adequate cooling for the above units/parts and then exhausted out of chamber through outlet slots. Therefore the cooling system provides a rational cooling for the engine, ensuring effective cooling for the engine where it generates most heat (around the cylinders, exhaust pipes, oil case in engine bottom), thereby providing a highly efficient cooling for the engine.

### FIELD OF THE TECHNOLOGY

The present invention relates to a gasoline generator and belongs to the technology field of motive power equipment.

### DESCRIPTION OF THE RELATED ART

The enforced air-cooled generator requires adequate quantity of cool air to cool off the highly heated parts of the generator (engine's cylinder head, crank case, permanent magnet generator etc.), at the same time, it has to meet the environmental protection requirements that are daily becoming more demanding. That is why the whole set must feature an elegant appearance, small contamination, low energy consumption and high utilization efficiency of space.

Prior to the present invention, the existing structure of generator would usually has one of the following two structural forms: 1: open frame structure, which meets the requirement of heat diffusion of the set to the greatest extent and is low in manufacturing cost but which cannot meet the environmental protection targets; 2. closed structure, which puts every functional part of the set in a closed case, and meets the requirement of heat diffusion by a complicated ducting system, and which meets the environmental requirement and expectations of aesthetics, but results in a high manufacturing cost and high price as a product and it is not suitable for mass production as the process technology is complicated.

Closed generator available on current market, encloses the whole motive power and generator unit and has to adopt complicated ducting system for the heat diffusion of the set and uses large capacity muffler with irregular geometrical contour for low level noise emission. However such structure tends to increase the whole set's outer dimensions and weight and makes the type heavier compared with equal mechanical performance and difficult to fit in various personalized environments.

In the existing technology, cooling setup of generator set is normally a fully enclosed cooling/ventilating chamber, i.e. containing the whole structural setup of engine, generator, exhaust pipe, and muffler in a closed shell and cooling the surfaces of above units with cool air sucked in by suction air fan, and then exhausting the air through air slots out of the chamber. Such cooling structure does not have much area of contact. While the cooling/ventilating chamber easily ensure the requirement of sealing, it cannot guarantee full cooling for the engine where greatest amount of heat generates (around the engine cylinders, exhaust pipe, and engine bottom oil plate)

### SUMMARY OF THE INVENTION

This invention aims to overcome the above defects and provide compact gasoline generator with simple structure and well sealed cooling air duct that ensures cool air sucked in by the fan goes entirely through the cooling duct for the cooling of the engine, thereby ensuring the high efficient operation of the engine and that also has good isolation effect.

The invention has its main solutions as follows:

Main structural parts of the invention has at least one closed case 10, the gasoline engine 20 is in this closed case 10; permanent magnet generator 30 is mounted on the housing of the engine 20; handle tray 40 is mounted on the front end surface of cool air suction cover 5, which is joined to the engine housing 21 with fasteners; handle tray 40, joined to the cool air suction cover 50 with fasteners, forming the main air inlet duct for cooling of motive power.

The closed case 10 of this invention comprises: the case fore cover assembly 11, case body cover assembly 12, case rear cover assembly 13, case bottom plate 14, metal frame 15 and lifting handle 16. Metal frame 15 is mounted on the case bottom plate 14, and the case body cover assembly 12 is fixed on the case bottom plate 14 and metal frame 15; case fore cover assembly 11, case rear cover assembly 13 are fastened respectively to metal frame 15.

In the present invention, the engine 20 includes at least one engine housing 21, engine housing side cover 22, engine crank shaft 23, engine upper air guide plate 24, engine bottom air guide plate 25, engine cylinder head 26, cylinder head cover 27, muffler 28 and the muffler cover 29. Cylinder head cover 27 is joined to cylinder head 26 with fasteners and the upper air guide plate 24 on the engine housing 21 is mounted on the engine main shaft 23 and the upper part of the engine housing 21, which is parallel with the engine mounting surface, thereby forming cooling air channel A. The engine bottom air guide plate 25 is mounted on the engine main shaft 23 and the case bottom part of the engine housing 21 which is parallel with the engine's mounting surface, thereby forming cooling air channel C.

In the present invention, the muffler cover 29 is engaged with the engine housing side cover 22 and muffler 28 is mounted on the flange surface in the muffler cover 29 and mounting the flange surface on the side of engine housing side cover 22, which forms the interior of the chamber.

Compared with existing technology, the present invention has the following advantages:

The structure of the present invention is simple, compact and rational. Adoption of cool air suction cover and air guide plates envelops partly the high temperature parts of the engine and the whole set of generator, exhaust pipe and muffler, all of which are adequately cooled by the cooling air sucked in with the suction fan, with the air exhausted out of the chamber through outlet slots after cooling. All that makes the engine-cooling a more rational setup, ensuring effective cooling off of the engine where it generates the greatest amount of heat and achieving a highly efficient cooling for the engine.

### DETAILED DESCRIPTION OF THE PREFERRED EMBODIMENT

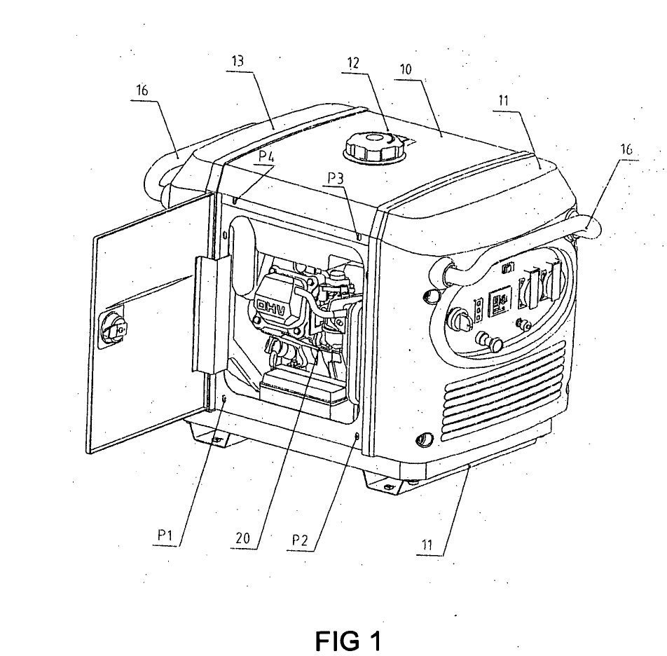

FIG. 1 is the perspective view of the present invention;

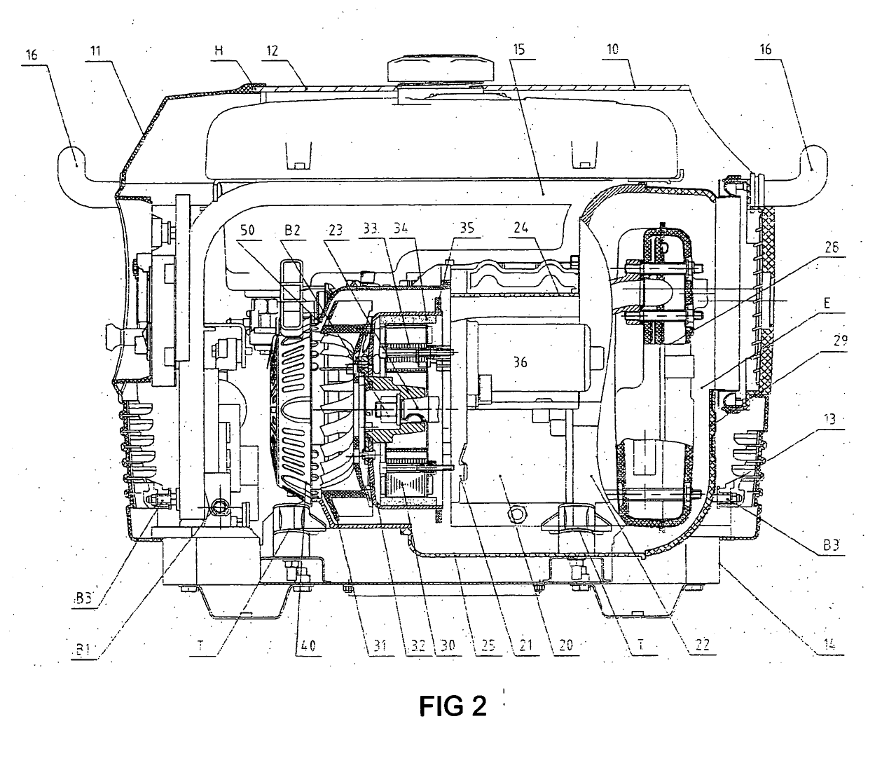

FIG. 2 is the front view of assembled structure of the present invention;

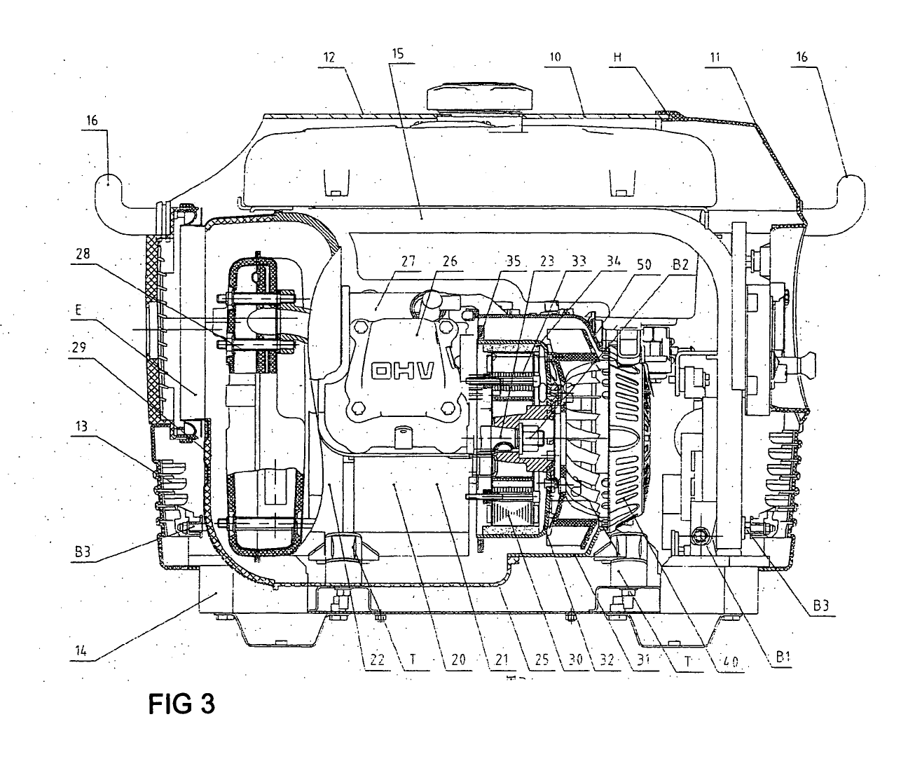

FIG. 3 is the rear view of the assembled structure of the present invention;

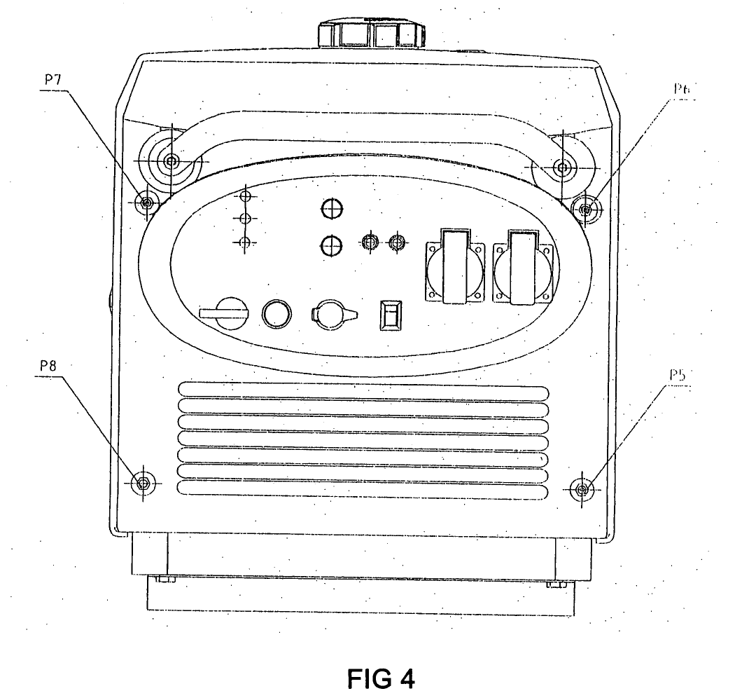

FIG. 4 is the right view of the assembled structure of the present invention;

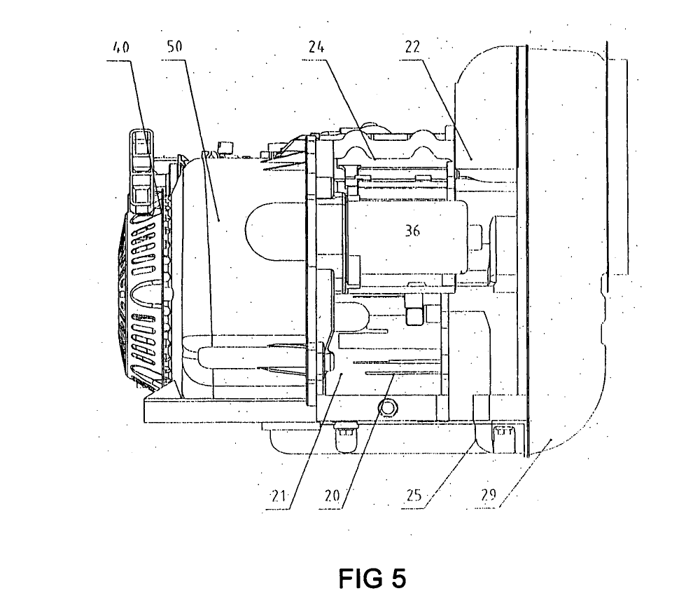

FIG. 5 is the front view of the assembled engine, generator, handle tray, cool air suction cover;

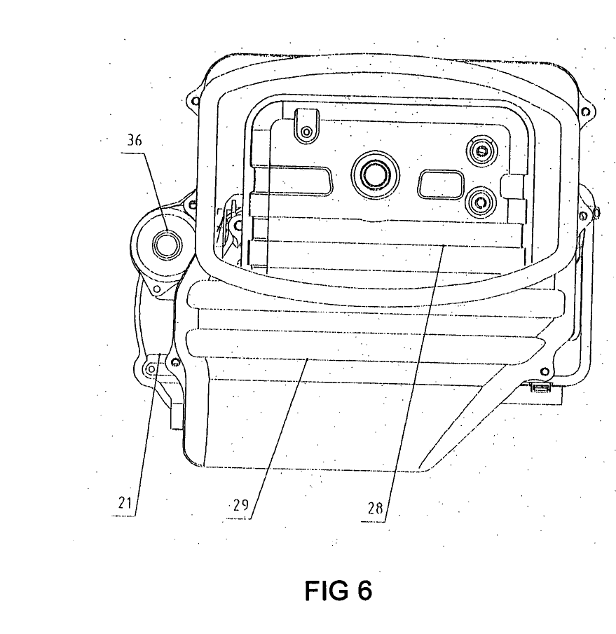

FIG. 6 is the right view of the assembled engine, generator, handle tray, cool air suction cover;

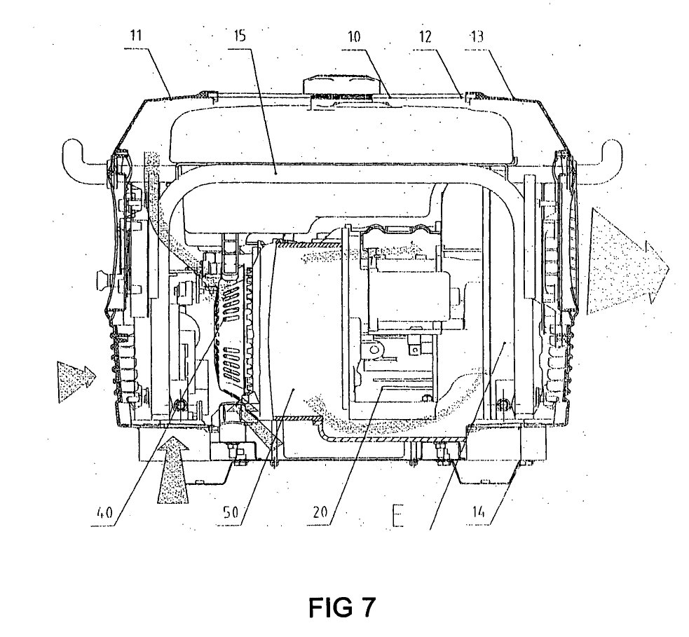

FIG. 7 is the front view of the cooling principle of the present invention;

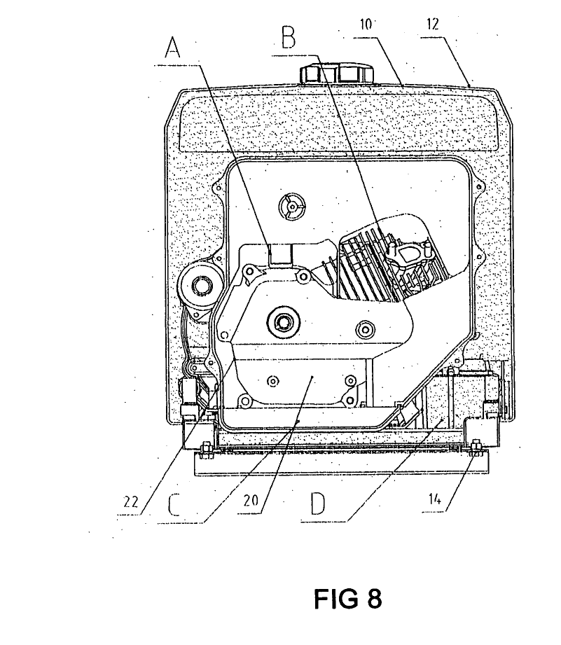

FIG. 8 is the right view of the cooling principle of the present invention;

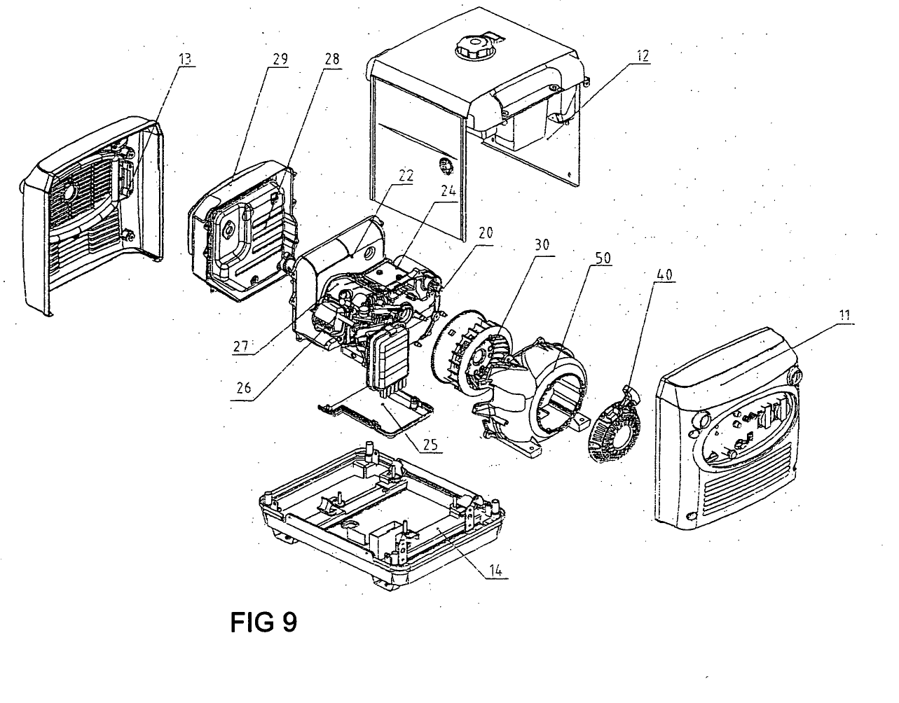

FIG. 9 is a exploded view of the main parts of the cooling structure of the present invention;

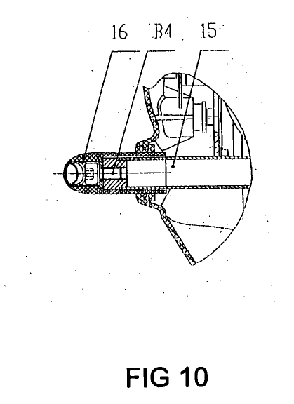

FIG. 10 is the mounting schematic of lifting handle of the present invention.

### DETAILED DESCRIPTION OF THE PREFERRED EMBODIMENT

Following is a more detailed description of the present invention with reference to the embodiment shown by the figures:

In the figures, the present invention is shown, the signs: up, down, left, right, front, rear indicate the directions.

Signs of the fasteners, holes, key ways in the figures are shown with letters as B1, B2, B3, B4 and etc.

As shown in FIG. 1 and FIG. 2:

the main structural units of this generator comprises at least one closed engine case housing 10, which is divided into five assemblies:

Fore case assembly 11, case body cover assembly 12, case rear assembly 13, case bottom plate 14, metal frame 15, lifting handle 16. Four tenon holes are in the four support feet of the metal frame 15 and four threaded mounting holes (the figure shows only one), and when the four tenon holes in the frame 15 and the four tenons at the four corners of case bottom plate 14 insert in each other and the locking nut B1 is tightened (figure showing only one), metal frame 15 is secured fixed on the case bottom plate 14.

In the fore and rear of the case body cover assembly 12 are four threaded mounting holes each (see FIG. 1, P1, P2, P3 and P4). They are used to fix the assembly to the metal frame 15 and case bottom plate 14. After mounting the case cover body assembly 12, the case fore assembly 11 and rear assembly 13 can be mounted. In each of them are four mounting holes (see FIG. 1, P5, P6, P7 and P8) and the keyway H for inserting in each other with the case body cover (see FIG. 2). Then align the mounting holes of fore case assembly 11 to the weld bolts B3 on the metal frame 15 and press in forcefully, so that the case body cover assembly 12 has its side inserted in the keyway H, and then use a screw driver to tighten the screws in the four mounting holes and the weld bolt B3 in the metal frame 15 to finish the mounting of the case fore case assembly 11.

Mounting of case rear assembly 13 is similar to that of the fore case assembly 11. Lifting handle 16 is mounted on the engine body. At the bottom of the fore end of case bottom plate 14 and at the low part of the case assembly 11 are the main air inlet, through which cooling air comes into the enclosed case. In the upper part of the case rear assembly is the air outlet as the main outlet of the entire case. It serves to keep the main cooling channel through and reduce the retardation of air flow in the case, thereby raising the cooling air flow amount per unit time.

Due to the simple structure and large interior space, it is possible to apply more sound absorbing material on the inner surface of components of each assembly to reduce noise, and thanks to the large interior space noise generated by the engine is subjected to a second reduction in the case. As the components in the case are few and the simple structure makes effective utilization of the space so that the entire machine set is smaller than other same kind types. Simple production and assembling process of the entire machine makes it easy for mass production. Air inlet/outlet at the fore and rear of the case provide free air flow, guaranteeing the air flow per unit time in the sealed space of the case. The effect of reduction is obvious, as a result of high utilization rate of space in the case it is possible to have larger oil tank capacity and muffler capacity compared with the same type with the same power while keeping a smaller outer dimensions, which provides a good noise-elimination effect.

After the gasoline engine 20, generator 30, cool air suction cover 50 and handle tray 40 are assembled, they are mounted on the internal vibrate absorbing pad T in the closed case (only two is shown) and fix with screws as shown in FIG. 5 and FIG. 6.

The engine housing 21 has flanged surfaces in both fore and rear side that engaged with cool air suction cover 50 and engine housing side cover 22; in which the fore flange surface is tightly joined to suction cover 50 with fasteners, while the rear flange surface is fastened to the housing side cover 22 with fasteners. In this way the generator 30 that is inside the suction cover 50 is entirely enclosed in the space formed by the joining of suction cover 50 and engine housing 21 and by the assembling suction cover 50 and handle tray 40. This setup also ensures that cooling air sucked in by cooling fan 31 does not enter into the interior of the enclosed case 10.

The gasoline engine 20 is a single cylinder engine with the valve at the top, which includes: the engine housing 21 assembled with it, cylinder head 26, engine cover 27, engine housing side cover 22, bottom air guide plate 25, upper air guide plate 24; the engine has a horizontal output crank shaft 23, muffler 28 and muffler cover 29.

It is mentioned particularly that the engine housing side cover 22, which has two flanged surfaces, in both fore and rear side. The fore flanged surface engaged with the rear flanged surface of engine housing 21, and together with the air guide plate 24 which is mounted on the upper part of engine housing 21 and the bottom air guide plate 25 which mounted at the bottom of engine housing 21, the cylinder head 26 and cylinder head cover 27, forms the main ventilating channel for the cooling of the engine. Cooling air channel goes through the main channel into the muffler chamber, is formed by muffler cover 29 and the housing side cover 22 which engaged with each other at flanged surfaces, and cools off the muffler 28.

Muffler cover 29 engaged with the housing side cover 22. Muffler 28 is normally in box type and is fixed in the rear of engine housing 22. Outlet of combustion waste gas is set at the rear of muffler 28.

Generator 30 is a permanent magnet generator with an external rotor 32, which is driven by engine 20, and that means the generator is engine driven generator. Generator 30 includes an iron core 33 which mounted on generator housing 21 and fitted with coils; an cup-shape external rotor 32 which mounted on the above said output crank shaft of the engine 20 and multiple permanent magnets 34 fitted on the inner circumference of it.

The external rotor 32 is designed to surround the iron core 33 with its coils. Cooling fan 31 is mounted in front of the external rotor 32. The rotor has high rigidity and big diameter so as to facilitate the mounting of big-diameter cooling fan, which can generate enough cooling air to cool off the high heated parts of the engine and generator. At the same time the external rotor 32 also serves as flywheel for engine 20, so that it has no need for any single flywheel. At the outer circumference are press-fitted with electrically-run gear ring 35, which transmits the torque of startup motor 36 to start the engine 20.

The output crank shaft 23 of engine 20, external rotor 32, cooling fan 31 and handle tray 40 are coaxial. External rotor 32 has ventilating holes in it to suck in cool air for fan 31 and to cool off engine 20 with its combustion heat and generator 30 with its heat from copper loss and iron loss.

The handle tray 40 is mounted at the fore end surface of cool air suction cover 50. Between them is a clearance which serves to increase the flow amount of cool air sucked in the cover.

The cool air suction cover 50 of the generator set is fixed to the engine housing 21 with fasteners, handle tray 40 is joined to cool air suction cover 50 with fasteners to form the main power cooling air inlet channel.

Engine cylinder head cover 27 is joined to cylinder head 26 with fasteners, upper air guide plate 24 is fixed to the engine housing 21 with fasteners and the bottom air guide plate 25 is joined to engine case 21 with fasteners and engine housing side cover 22 to form the two main cooling channels A and B at the upper part of the engine. (See FIG. 8)

Engine crank housing side cover 22, muffler cover 29, bottom air guide plate 25 form the main cooling channels A and B.

An enclosed assembling structure formed by the assembling of the air collecting chamber E (see FIG. 7) of the bottom main cooling air channel C, the muffler cover 29, engine housing side cover 22, upper air guide plate 24, engine housing 21, bottom air guide plate 25, permanent magnet generator 30 with cooling fan, fan cover 50, handle tray 40, engine cylinder head 26, cylinder head cover 27 together with the enclosed assembling structure formed by the assembling of engine case rear cover 13, case body cover 12, case fore cover 11 and case bottom plate 14 form the secondary cooling cycle chamber D.

After the above parts/components are assembled, the generator set has its complete cooling system formed.

To ensure the closed flow of cooling air, sealing material can be applied to the contact surfaces of the above mentioned units for sealing. At the same time the joining of the relevant parts/units is by tongue and groove, which serves the purpose of sealing as well as simplifies the assembling process.

Working principle of the present invention: small quantity of warm air from enclosed case in the cool air suction cover 50 goes to cool the permanent magnet generator 30 first, then its goes through the left and right main cooling air channels A and B at the upper part of the engine and main cooling channel C at the bottom of the engine housing 21 to cool off the cylinder radiator of engine housing 21, and cylinder head 26, upper part of the engine housing 21, bottom of the engine housing 21 and again cools off the muffler 28 located in the chamber formed up by the assembled muffler cover 29 and housing side cover 22. The air is exhausted to the outside through the channel connected with the interior chamber of the case which is formed by assembling the open part of muffler cover 29, case bottom plate 14, case fore cover assembly 11, case body cover assembly 12, case rear cover assembly 13 with the outside. The present invention of cooling system can be used for the design of cooling air ducting for closed case type generator with forced air-cooled engine as motive power.

Following is an analysis of the cooling system's performance characteristics:

The Adoption of air guide plates with suction cover envelops partly the high temperature parts of the engine and the whole set of the generator, exhaust pipe and muffler; all of which are adequately cooled by the cooling air sucked in with the suction fan, with the air exhausted out of the chamber through outlet slots after cooling. All that makes the engine-cooling a more rational setup, ensuring effective cooling off of the engine where it generates the greatest amount of heat and achieving a highly efficient cooling for the engine.

The engine housing side cover 22 in particular, designed as shown in FIG. 9, greatly increases the heat diffusion area of the engine 20 and at the same time makes assembling much easier as the assembling process is simplified.

What is claimed:

1. A gasoline generator, which mainly comprises: gasoline engine (20), generator (30), characterized in that: at least one enclosed engine case (10), in which is located the gasoline engine (20), the permanent magnet generator (30) is mounted on the engine housing (21), the handle tray (40) is mounted on the fore end surface of cool air suction cover (50), and the cool air suction cover (50) is joined to the engine housing (21) with fastener; handle tray (40), joined to the suction cover (50) with fasteners, together form the main cooling air inlet channel for the motive power.

2. The gasoline generator according to claim 1, wherein a said closed engine case (10), comprising: the fore cover assembly (11), case body cover assembly (12), case rear cover assembly (13), case bottom plate (14), metal frame (15) and lifting handle (16); the metal frame (15) is mounted on the case bottom plate (14), the case body cover assembly (12) is mounted on the case bottom plate (14) and metal frame (15); the case fore cover assembly (11) and rear cover assembly (13) are fastened to the metal frame (15) respectively.

3. The gasoline generator according to claim 1, wherein said gasoline engine (20), which includes at least one engine housing (21), housing side cover (22), engine crank shaft (23), upper part air guide plate (24), bottom air guide plate (25), cylinder head (26), cylinder head cover (27); the cylinder head cover (27) is joined to the cylinder head (26) with fasteners, housing (21) has its upper air guide plate (24) mounted on the upper part of the engine housing (21) and the engine's mounting surface, case which runs parallel with crank shaft (23) forming the cooling air channel A; the bottom air guide plate (25), mounted on the bottom of the engine housing (21) and the engine's mounting surface, which runs parallel with engine crank shaft (23) forming the cooling air channel C.

4. The gasoline generator according to claim 1, wherein said muffler (28) is mounted inside the chamber formed by muffler cover (29) flanged surface, which engaged with the flanged surface on the side of housing side cover (22).

5. The gasoline generator according to claim 1, wherein a main air inlet at the bottom of fore end of case bottom plate (14) and lower part of case fore cover assembly (11)

6. The gasoline generator according to claim 1, wherein an air outlet being set at the upper part of the case rear cover assembly (13)
